(19) United States
(12) Patent Application Publication
(10) Pub. No.: US 2012/0282537 A1
(43) Pub. Date: Nov. 8, 2012

(54) FUEL CELL

(75) Inventors: Atsushi OHMA, Yokohama-shi (JP); Yoshitaka ONO, Yokosuka-shi (JP); Ryoichi SHIMOI, Yokohama-shi (JP); Kazuya TAJIRI, State College, PA (US)

(73) Assignee: NISSAN MOTOR CO., LTD.

(21) Appl. No.: 13/551,573

(22) Filed: Jul. 17, 2012

Related U.S. Application Data
(63) Continuation of application No. 13/166,544, filed on Jun. 22, 2011.
Application No. 13/166,544 is a continuation of application No. 10/594,385, filed on Sep. 27, 2006, now abandoned.

(30) Foreign Application Priority Data
Mar. 30, 2004 (JP) 2004-101373

(51) Int. Cl. H01M 8/04; H01M 8/10

(52) U.S. Cl. 429/437; 429/482

(57) ABSTRACT

A fuel cell comprises a cathode catalyst layer and an anode catalyst layer disposed on each surface of an electrolyte membrane, an oxidant gas passage facing the cathode catalyst layer, and a fuel gas passage facing the anode catalyst layer. The cathode catalyst layer contains a metal catalyst. In a region (A), in which the differential electric potential between the cathode catalyst layer and the electrolyte membrane is larger than in another region, the metal catalyst content of the cathode catalyst layer or the specific surface area of the metal catalyst in the form of minute particles is increased, and thus a deterioration in electric power generation efficiency caused by melting of the metal catalyst due to the large differential electric potential is prevented.

### CROSS-REFERENCE TO RELATED PATENT APPLICATIONS

This application is a Continuation application of U.S. Ser. No. 13/166, 544 filed Jun. 22, 2011, which is a Continuation of U.S. Ser. No. 10/594, 385 filed Sep. 27, 2006, which claims the benefit of PCT/JP2005/002952 filed Feb. 17, 2005, which claims the benefit of Japanese Appln No: 2004-101373 filed Mar. 30, 2004, all of which are fully incorporated herein by reference.

### FIELD OF THE INVENTION

This invention relates to a constitution of a cathode catalyst layer of a polymer electrolyte fuel cell.

### BACKGROUND OF THE INVENTION

JP2003-168443A, published by the Japan Patent Office in 2003, teaches that the constitution of a cathode catalyst layer is to be varied according to its position in order to improve the operating efficiency of a polymer electrolyte fuel cell (PEFC).

A fuel cell comprises an anode and a cathode, a solid polymer electrolyte membrane supported between the anode and cathode, a separator contacting the cathode on the opposite side of the electrolyte membrane, and a separator contacting the anode on the opposite side of the electrolyte membrane. A gas passage for introducing an oxidant gas is formed in the separator contacting the cathode.

In this prior art, the constitution of the cathode catalyst layer is varied such that the amount of platinum and the amount of an ion exchange resin per unit area of the cathode catalyst layer is greater in the vicinity of the inlet to the gas passage than in the vicinity of the outlet from the gas passage.

The electrolyte membrane is required to be moist, but since water is generated as a result of a reaction between fuel gas and oxidant gas in the fuel cell, the oxidant gas supplied to the cathode preferably has low humidity in consideration of the overall reaction efficiency. As a result, the atmosphere in the vicinity of the inlet to the gas passage is dry, and the atmosphere in the vicinity of the outlet is humid. The prior art achieves a uniform reaction efficiency in all regions of the cathode by increasing the amount of platinum and/or the amount of ion exchange resin per unit area in the vicinity of the inlet accordingly.

### SUMMARY OF THE INVENTION

However, when a fuel cell is exposed to high temperatures or high electric potentials, a metal catalyst formed from platinum (Pt) or the like tends to melt through oxidation such that the substantial reaction area of the cathode decreases. The position in which the metal catalyst melts is not limited to the upstream side of the gas passage, and is determined by the electric potential distribution. Hence in a specific region of the cathode where oxidation of the metal catalyst is likely to occur, the electric power generation efficiency decreases when the fuel cell is operated over a long time period. The prior art is unable to remedy such melting of the metal catalyst caused during a long operating period.

It is therefore an object of this invention to maintain a favorable reaction efficiency in all regions of a cathode over a long period of usage.

In order to achieve the above object, this invention provides a fuel cell (1) comprising an electrolyte membrane (2), and a cathode catalyst layer (3) supporting a metal catalyst (16). The cathode catalyst layer (3) faces a surface of the electrolyte membrane (2) in plural regions including a specific region in which a differential electric potential between the cathode catalyst layer (3) and the electrolyte membrane (2) during an electric power generation reaction of the fuel cell (1) is larger than in another region. One of a supported amount of the metal catalyst (16) and a specific surface area of the metal catalyst (16) in the specific region is set to have a larger value than in the region other than the specific region.

The details as well as other features and advantages of this invention are set forth in the remainder of the specification and are shown in the accompanying drawings.

### BRIEF DESCRIPTION OF THE DRAWINGS

FIG. 1 is a longitudinal sectional view of a fuel cell according to this invention.

FIGS. 2A and 2B are perspective views of a catalyst particle according to this invention.

FIG. 3 is a schematic longitudinal sectional view of a fuel cell, illustrating a region A set in this invention.

FIG. 4 is a plan view of a membrane electrode assembly according to a fourth embodiment of this invention.

FIGS. 5A and 5B are a front view and a rear view of a separator according to the fourth embodiment of this invention.

FIG. 6 is a schematic longitudinal sectional view of a fuel cell, illustrating a region A set in a fifth embodiment of this invention.

FIG. 7 is a schematic longitudinal sectional view of a fuel cell, illustrating a region A set in a sixth embodiment of this invention.

FIG. 8 is a perspective view of a fuel cell stack using the fuel cell according to this invention.

### DESCRIPTION OF THE PREFERRED EMBODIMENTS

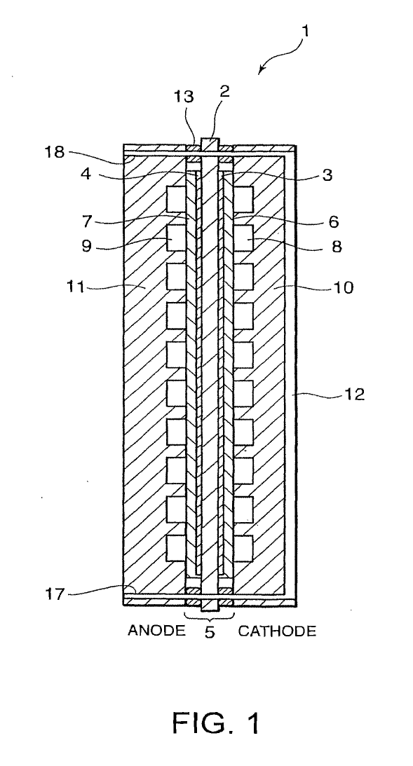

Referring to FIG. 1 of the drawings, a fuel cell 1 comprises a membrane electrode assembly 5, and a pair of separators 10 and 11 sandwiching the membrane electrode assembly 5 from either side.

The membrane electrode assembly 5 has a cathode catalyst layer 3 formed on one surface of a solid polymer electrolyte membrane 2, the outside of which is covered by a gas diffusion layer 6, and an anode catalyst layer 4 formed on the other surface of the solid polymer electrolyte membrane 2, the outside of which is covered by a gas diffusion layer 7.

The cathode catalyst layer 3, anode catalyst layer 4, and gas diffusion layers 6, 7 are formed with a planar form that is identical to, but slightly smaller than, the solid polymer electrolyte membrane 2 and the separators 10, 11. With the membrane electrode assembly 5 sandwiched between the pair of separators 10, 11, the cathode catalyst layer 3 and gas diffusion layer 6 are enclosed within a gasket 13 that is supported between the solid polymer electrolyte membrane 2 and the separator 10. Likewise, the anode catalyst layer 4 and gas diffusion layer 7 are enclosed within a gasket 13 that is supported between the solid polymer electrolyte membrane 2 and the separator 11.

A plurality of groove-shaped oxidant gas passages 8 facing the gas diffusion layer 6 is formed in the separator 10. A plurality of groove-shaped fuel gas passages 9 facing the gas diffusion layer 7 is formed in the separator 11. Air containing oxygen flows through the oxidant gas passages 8, and hydrogen rich gas having hydrogen as its main component flows through the fuel gas passages 9, preferably in opposite directions to each other. It should be noted, however, that the gases do not necessarily have to flow in opposite directions.

Oxidant gas is distributed to the oxidant gas passages 8 from an oxidant gas supply manifold formed so as to pass vertically through the fuel cell 1. Fuel gas is distributed to the fuel gas passages 9 from a fuel gas supply manifold formed so as to pass vertically through the fuel cell 1.

A cooling water passage 12 is formed on the rear surface of the cathode side separator 10. The two ends of the cooling water passage 12 are connected to a cooling water supply manifold 17 and a cooling water discharge manifold 18 which pass through the fuel cell 1 in a longitudinal direction. Cooling water supplied to the cooling water passage 12 from the cooling water supply manifold 17 cools the fuel cell 1 following heat generation produced by the electrochemical reaction in the fuel cell 1 so that the temperature of the fuel cell 1 is maintained appropriately. Having absorbed the generated heat of the fuel cell 1, the cooling water is discharged outside of the fuel cell 1 from the cooling water passage 12 through the cooling water discharge manifold 18.

Referring to FIG. 8, the fuel cell 1 constituted as described above is laminated together with other fuel cells 1 having a similar constitution, and used as a fuel cell stack 100 having a pair of end plates 201 disposed at each end.

In the fuel cell 1, the hydrogen contained in the hydrogen-rich gas that is supplied to the fuel gas passage 9 passes through the gas diffusion layer 7 to reach the anode catalyst layer 4, and causes the following reaction in the anode. The oxygen contained in the air that is supplied to the oxidant gas passage 8 passes through the gas diffusion layer 6 to reach the cathode catalyst layer 3, and causes the following electrochemical reaction in the cathode. The electric potential that is generated as a result of the reactions is expressed as a voltage based on the Standard Hydrogen Electrode (SHE).

Anode: 2H₂→2H⁺+2e⁻(0V)

Cathode: 0₂+4H⁺+4e⁻→2H₂0(1.23V)

As shown in these reaction formulae, in the fuel cell 1 the cathode reaches a higher electric potential than the anode.

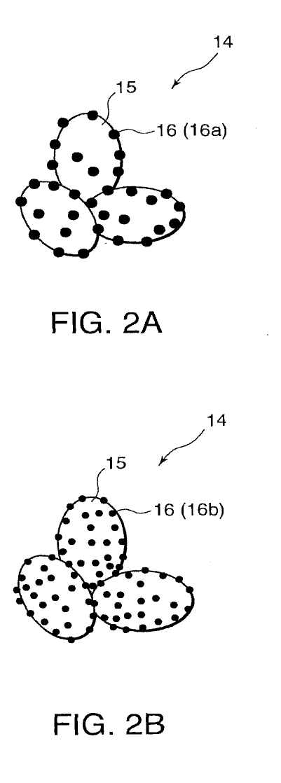

Referring to FIGS. 2A and 2B, the cathode catalyst layer 3 is constituted by a large number of catalyst particles 14. The catalyst particles 14 contains a metal catalyst 16 which is supported on a support 15 in the form of minute particles and generates an electrochemical reaction in the cathode. In this embodiment, carbon black is used for the support 15, and platinum particles are used for the metal catalyst 16. It should be noted, however, that this invention does not exclude the use of other materials for the support 15 or metal catalyst 16. The cathode catalyst layer 3 is formed by coating the electrolyte membrane 2 with a solution of the catalyst particles 14 constituted in such a manner. The anode catalyst layer 4 is constituted similarly to the cathode catalyst layer 3.

When the fuel cell 1 described above is in a state of high electric potential, an oxidation reaction shown in the following reaction formula is generated in the metal catalyst 16 of the cathode catalyst layer 3. The voltage shown in parentheses is based on the aforementioned SHE.

Pt→Pt²⁺+2e⁻(1.19V)

More specifically, the platinum initiates the oxidation reaction at a differential electric potential of approximately 1.2V. The oxidation reaction occurs more easily as the differential electric potential between the cathode catalyst layer 3 and the electrolyte membrane 2 increases. On the periphery of the differential electric potential of 1.2V, the oxidation reaction begins even at a lower electric potential than 1.2V.

The platinum is melted by the oxidation reaction, and as a result, the surface area of the catalyst decreases, leading to a deterioration in the catalytic function of the cathode catalyst layer 3. A deterioration in the catalytic function causes the electric power generation efficiency of the fuel cell 1 to decrease.

The electric potential E of the electrolyte membrane 2 based on SHE is dependent on the proton concentration [H⁺] passing through the electrolyte membrane 2, as is expressed by the following equation.

$$E = \frac{a}{2.303} \cdot ln [ {H}^{+} ] or E = a \cdot {log}_{10} [ {H}^{+} ]$$

where, a=temperature-dependent constant.

The constant a is 0.059 at twenty-five degrees centigrade. The term In expresses a natural logarithm, whereas log₁₀ expresses a common logarithm.

As is clear from the above equation, the electrolytic potential rises as the proton concentration [H⁺] passing through the electrolyte membrane 2 increases. As a result, the differential electric potential with the cathode catalyst layer 3 decreases. As the proton concentration [H⁺] passing through the electrolyte membrane 2 decreases, the electrolytic potential falls, and hence the differential electric potential with the cathode catalyst layer 3 increases.

The proton concentration [H⁺] passing through the electrolyte membrane 2 is closely related to the current density of the reaction surface of the fuel cell 1. In other words, in locations where the current density is low, the proton concentration [H⁺] passing through the electrolyte membrane 2 is low, and in locations where the current density is high, the proton concentration [H⁺] passing through the electrolyte membrane 2 is high.

The proton concentration [H⁺] passing through the electrolyte membrane 2 is dependent on the moisture content of the electrolyte membrane 2 such that the proton concentration [H⁺] falls as the moisture content increases.

From the relationships described above, regarding the oxidant gas flow, the differential electric potential between the cathode catalyst layer 3 and electrolyte membrane 2 is high on the downstream side of the oxidant gas flow. As noted above, water is generated in the cathode by the reaction between the hydrogen and oxygen, and this water mixes with the oxidant gas in the oxidant gas passage 8. Meanwhile, the oxygen in the oxidant gas is consumed in the reaction in the cathode. As a result, the humidity of the oxidant gas rises toward the downstream side of the oxidant gas passage 8. Accordingly, the moisture content of the electrolyte membrane 2 also increases toward the downstream side of the oxidant gas passage 8, whereas the proton concentration [H⁺] decreases.

In other words, even when the SHE-based electric potential of the cathode catalyst layer 3 is constant, toward the downstream side of the oxidant gas passage 8 the electric potential of the electrolyte membrane 2 decreases, and the differential electric potential between the cathode catalyst layer 3 and electrolyte membrane 2 increases. Furthermore, the current density decreases toward the downstream side of the oxidant gas passage 8.

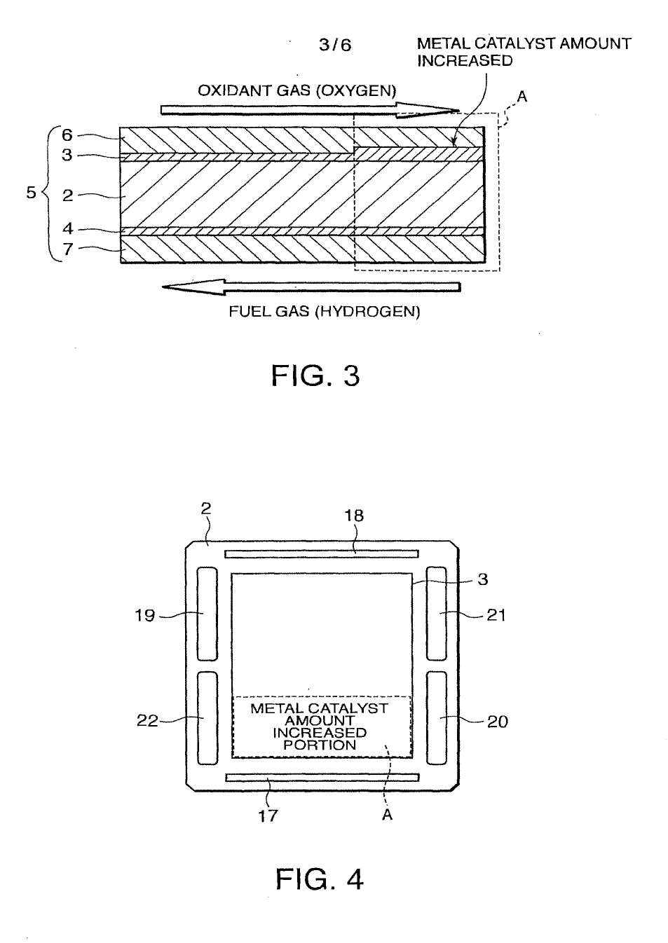

Referring to FIG. 3, here, the downstream region of the oxidant gas passage 8 is set as a region A in which the differential electric potential between the cathode catalyst layer 3 and electrolyte membrane 2 is large. In the region A, the amount of the metal catalyst 16 per unit area of the cathode catalyst layer 3 is set to be larger than in the other region. More specifically, in the region A, the coated amount of the catalyst particles 14 onto the electrolyte membrane 2 to form the cathode catalyst layer 3 is increased beyond that of the other region. To explain in the simplest way, the coated amount of the catalyst particles 14 can be increased by increasing the number of times of coating.

Here, the coated amount of the catalyst particles 14 in the region A is set at 0.6 mg/cm², and the coated amount of the catalyst particles 14 in the other region is set at 0.4 mg/cm².

Thus by increasing the amount of the metal catalyst 16 in the region A, in which the metal catalyst 16 of the cathode catalyst layer 3 is more likely to melt due to the differential electric potential, a decrease in output voltage caused by melting of the metal catalyst 16 in the region A can be prevented. As a result, a uniform reaction efficiency can be maintained in all regions of the cathode over a long time period, and decreases over time in the output of the fuel cell 1 can be prevented, enabling an improvement in durability.

In this embodiment, the region A is set as the downstream region of the oxidant gas passage 8, but the high-humidity region of at least one of the oxidant gas passage 8 and fuel gas passage 9 may be set as the region A. When flooding occurs in the fuel gas passage 9, fuel gas supply becomes insufficient, and carbon corrosion or platinum corrosion may occur as a result. By setting the region A according to the humidity of the fuel gas passage 9 as well as the humidity of the oxidant gas passage 8, decreases in the output of the fuel cell 1 due to such corrosion can be prevented.

As is clear from the above description, the region A, in which the differential electric potential between the cathode catalyst layer 3 and electrolyte membrane 2 is large, may be defined in various ways in accordance with its relationship to the current density, the moisture content of the electrolyte membrane 2, and the oxidant gas passage 8.

Next, referring to FIGS. 2A and 2B, a second embodiment of this invention will be described.

In this embodiment, the specific surface area of the metal catalyst 16 is increased in the region A instead of the coated amount of the catalyst particles 14.

More specifically, metal catalyst particles 16a having the particle diameter shown in FIG. 2A are supported on the support 15 in the other region, whereas metal catalyst particles 16b having a smaller particle diameter, as shown in FIG. 2B, are supported on the support 15 in the region A. By reducing the particle diameter, the effective surface area of the particles which generate the electrochemical reaction increases. Hence by increasing the specific surface area of the metal catalyst 16, an identical action can be obtained without increasing the amount of the metal catalyst 16.

It should be noted that in this embodiment also, the region A may be defined in various ways, as described in the first embodiment. Next, a third embodiment of this invention will be described.

In this embodiment, the composition of the catalyst particles 14 is modified in the region A instead of increasing the coated amount of the catalyst particles 14.

More specifically, in the region A catalyst particles having a platinum weight proportion of fifty percent by weight are applied to the catalyst particles 14, whereas in the other region catalyst particles having a platinum weight proportion of forty percent by weight are applied to the catalyst particles 14. By means of this arrangement, the platinum amount contained in the cathode catalyst layer 3 can be modified without modifying the coated amount of the catalyst particles 14. It should be noted that it is also possible to modify the platinum amount contained in the cathode catalyst layer 3 without modifying the coated amount of the catalyst particles 14 by varying the mixing ratio of two types of catalyst particles having a different platinum weight proportion in the region A and the other region.

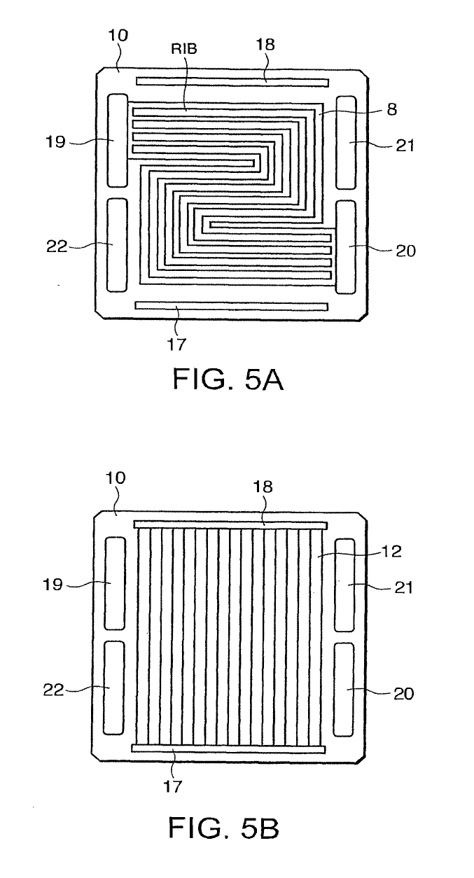

Next, referring to FIG. 4 and FIGS. 5A and 5B, a fourth embodiment of this invention will be described.

In the drawings, the electrolyte membrane 2 has a substantially square planar form, and the cathode catalyst layer 3 coated onto the electrolyte membrane 2 takes a square shape which is slightly smaller than that of the electrolyte membrane 2.

The cooling water supply manifold 17, cooling water discharge manifold 18, oxidant gas supply manifold 19, oxidant gas discharge manifold 20, fuel gas supply manifold 21, and fuel gas discharge manifold 22 are formed through the electrolyte membrane 2 and separators 10, 11 outside of the periphery of the cathode catalyst layer 3 and anode catalyst layer 4. The cooling water supply manifold 17 and discharge manifold 18 penetrate the square shape electrolyte membrane 2 at a rectangular cross section along two opposing sides of the square. The oxidant gas supply manifold 19 and fuel gas discharge manifold 22 are formed consecutively on one of the two remaining sides of the square, and the oxidant gas discharge manifold 20 and fuel gas supply manifold 21 are formed consecutively on the other of the two remaining sides of the square. The oxidant gas supplied through the supply manifold 19 flows down the oxidant gas passage 8, and is discharged outside of the fuel cell 1 through the discharge manifold 20. The fuel gas supplied through the supply manifold 21 flows down the fuel gas passage 9, and is discharged outside of the fuel cell 1 through the discharge manifold 22.

As shown in FIG. 5A, in this embodiment the oxidant gas passage 8 formed in the separator 10 is constituted by a plurality of bent parallel passages. Each passage is defined by a rib. As shown in FIG. 5B, the cooling water passage 12 formed in the separator 11 is constituted by a plurality of parallel passages connecting the supply manifold 17 and discharge manifold 18 linearly. The point of this arrangement is to ensure that the upstream portion of the cooling water passage 12 overlaps the downstream portion of the oxidant gas passage 8, and that the downstream portion of the cooling water passage 12 overlaps the upstream portion of the oxidant gas passage 8. It should be noted, however, that a similar overlapping relationship may be realized through another disposal arrangement of the oxidant gas passage 8 and cooling water passage 12.

In this embodiment, the region having a large differential electric potential between the electrolyte membrane 2 and cathode catalyst layer 3 is defined by the temperature of the cathode catalyst layer 3. More specifically, in the low temperature region of the cathode catalyst layer 3, condensed water is generated easily, and water is difficult to discharge. As a result, the moisture content of the electrolyte membrane 2 increases, and the electric potential of the electrolyte 2 falls, leading to a large differential electric potential with the cathode catalyst layer 3. Hence in this embodiment, the low temperature region of the cathode catalyst layer 3 is set as the region A. More specifically, the upstream portion of the cooling water passage 12 and the overlapping downstream portion of the oxidant gas passage 8 correspond to the region A. The amount or specific surface area of the metal catalyst 16 in the cathode catalyst layer 3 is increased in the region A, set as described above, by applying any one of the methods described in the first through third embodiments.

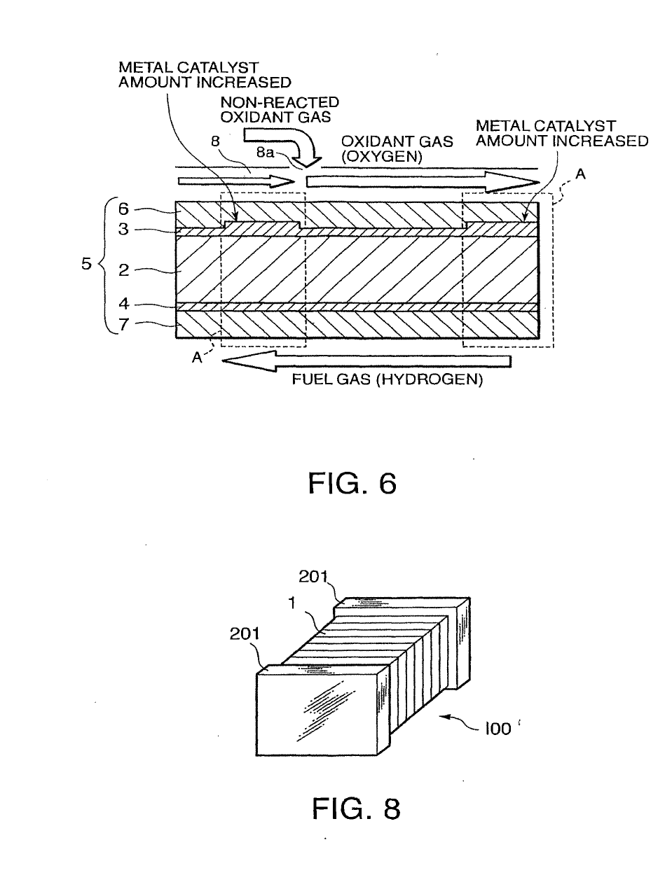

Next, referring to FIG. 6, a fifth embodiment of this invention will be described.

In this embodiment, non-reacted oxidant gas discharged into the oxidant gas discharge manifold is recirculated into a convergence portion 8a provided at a point midway along the oxidant gas passage 8. The region A is set in a different position to the first embodiment in accordance with the convergence portion 8a. Otherwise, the fifth embodiment is constituted identically to the first embodiment.

A method of setting the region A in this embodiment will now be described.

In the oxidant gas passage 8, the amount of oxidant gas is smaller directly before the non-reacted oxidant gas converges than after the convergence, and hence the ability to discharge the water generated in the oxidant gas passage 8 decreases, making the moisture content of the electrolyte membrane 2 likely to rise. Moreover, in this region the reaction rate of the electrochemical reaction in the cathode catalyst layer 3 between the hydrogen that passes through the electrolyte 2 and the oxygen in the oxidant gas supplied from the oxidant gas passage 8 decreases, and the current density falls. Thus in this region, the differential electric potential between the cathode catalyst layer 3 and electrolyte membrane 2 is likely to increase.

Therefore, in this embodiment the region directly upstream of the non-reacted oxidant gas convergence portion 8a, and the downstream portion of the oxidant gas passage 8, which is removed from the former region by a gap, are set as the region A. The amount or specific surface area of the metal catalyst 16 in the cathode catalyst layer 3 is increased in the region A, set in this manner, by applying any one of the methods described in the first through third embodiments.

According to this embodiment, the region A is set in accordance with variation in the oxidant gas flow rate through the oxidant gas passage 8, and hence application of this invention to a fuel cell comprising an oxidant gas recirculation mechanism can be optimized.

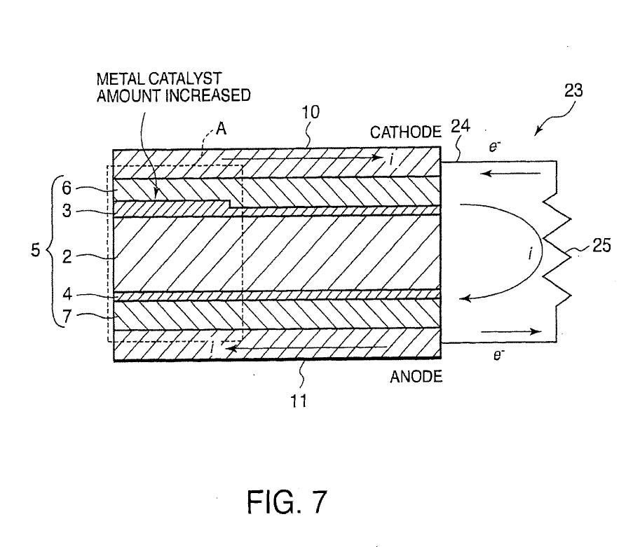

Next, referring to FIG. 7, a sixth embodiment of this invention will be described.

The fuel cell 1 according to this embodiment comprises a current extraction portion 23 on one end of the separators 10 and 11. The current extraction portion 23 is constituted by a lead wire 24 connecting one end of the separator 10 and one end of the separator 11, and an electric load 25 inserted at a point on the lead wire 24.

An electron e⁻ generated by the electric power generation reaction of the fuel cell 1 flows from the separator 11 on the anode catalyst layer 4 side through the electric load 25 to the separator 10 on the cathode catalyst layer 3 side, whereby a current is formed in the opposite direction to the flow of the electron e⁻. In the interior of the fuel cell 1, the inverse current flows along the lamination plane of the cathode catalyst layer 3, as shown by the arrow in the drawing, as the electron e⁻ is supplied to each portion of the cathode catalyst layer 3 from the lead wire 24. As a result, a differential electric potential is generated along the lamination plane of the cathode catalyst layer 3 such that the electric potential of the cathode catalyst layer 3 increases gradually from the connection portion between the separator 10 and the lead wire 24.

Meanwhile, away from the connection portion to the lead wire 24, a delay occurs in the supply of the electron e⁻ used in the electrochemical reaction in the cathode catalyst layer 3 due to electron transfer resistance in the separator 10, and hence a delay occurs in the electrochemical reaction. As a result, the proton concentration [H⁺] of the region removed from the connection portion to the lead wire 24 decreases, causing a decrease in the electric potential of the electrolyte membrane 2.

Hence the differential electric potential between the cathode catalyst layer 3 and electrolyte membrane 2 increases gradually as the distance from the connection portion to the lead wire 24 increases.

In this embodiment, therefore, the region of the cathode catalyst layer 3 that is removed from the connection portion to the lead wire 24 is set as the region A. In this embodiment, the amount or specific surface area of the metal catalyst 16 in the cathode catalyst layer 3 is increased in the region A, set in this manner, by applying any one of the methods described in the first through third embodiments.

By increasing the amount or specific surface area of the metal catalyst 16 in accordance with the distance from the current extraction portion 23, it is possible to compensate for melting of the metal catalyst 16 due to the high differential electric potential, and hence a uniform reaction efficiency can be maintained in all regions of the cathode over a long time period.

In this embodiment, the current extraction portion 23 is provided at the end portion of the separators 10 and 11, but in cases where current extraction portions are provided in a plurality of sites on the separators 10 and 11, the region A is set in accordance with the distance from each of the current extraction portions.

In a fuel cell stack constituted by a plurality of the fuel cells 1 laminated in a single direction, the current is typically extracted from both ends of the stack. In this case, a favorable effect is obtained by constituting the fuel cells at the end portions of the stack, in the vicinity of the current extraction portions, similarly to the fuel cell 1 of this embodiment.

The contents of Tokugan 2004-101373, with a filing date of Mar. 30, 2004 in Japan, are hereby incorporated by reference.

Although the invention has been described above by reference to certain embodiments of the invention, the invention is not limited to the embodiments described above. Modifications and variations of the embodiments described above will occur to those skilled in the art, within the scope of the claims.

For example, in each of the embodiments described above, the amount or specific surface area of the metal catalyst 16 in the cathode catalyst layer 3 is increased uniformly in the region A, but the increase amount may be raised gradually. For example, the amount or specific surface area of the metal catalyst 16 may be increased as the differential electric potential between the cathode catalyst layer 3 and electrolyte membrane 2 increases.

### INDUSTRIAL FIELD OF APPLICATION

As described above, this invention exhibits the favorable effects of an improvement in the durability of a fuel cell using a solid polymer electrolyte membrane and the conservation of its functions over a long time period.

The embodiments of this invention in which an exclusive property or privilege is claimed are defined as follows:

1. A fuel cell comprising:
a solid polymer electrolyte membrane;
a cathode catalyst layer provided on a side of the solid polymer electrolyte membrane, the cathode catalyst layer comprising catalyst particles each of which comprises a support and a metal catalyst supported on the support; and
a cathode separator facing the cathode catalyst layer, the cathode separator having an oxidant gas passage through which an oxidant gas flows, on a surface facing the cathode catalyst layer, and a cooling water passage through which a cooling water flows, on an opposite surface to the surface facing the cathode catalyst layer, the oxidant gas passage comprising an upstream portion and a downstream portion with respect to a flow of the oxidant gas and the cooling water passage comprising an upstream portion and a downstream portion with respect to a flow of the cooling water;
wherein a specific surface area of the particles in the cathode catalyst layer facing the downstream portion of the oxidant gas passage is smaller than a specific surface area of the particles in the cathode catalyst layer facing the upstream portion of the oxidant gas passage, and
wherein a specific surface area of the particles in the cathode catalyst layer facing the upstream portion of the cooling water passage is smaller than a specific surface area of the particles in the cathode catalyst layer facing the downstream portion of the cooling water passage.

2. The fuel cell as defined in claim 1, wherein the fuel cell comprises reaction surfaces, and a reaction surface of the fuel cell corresponding to the downstream portion of the oxidant gas passage has a smaller current density than a reaction surface of the fuel cell corresponding to the upstream portion of the oxidant gas passage.

3. The fuel cell as defined in claim 1, wherein a moisture content of the solid polymer electrolyte membrane is higher in an area corresponding to the downstream portion of the oxidant gas passage than in an area corresponding to the upstream portion of the oxidant gas passage.

4. The fuel cell as defined in claim 1, wherein a humidity of the oxidant gas is higher in a region corresponding to the downstream portion of the oxidant gas passage than in a region corresponding to the upstream portion of the oxidant gas passage.

5. The fuel cell as defined in claim 1, further comprising:
an anode catalyst layer provided on another side of the solid polymer electrolyte membrane, the anode catalyst layer comprising catalyst particles each of which comprises a support and a metal catalyst supported on the support; and
an anode separator facing the anode catalyst layer, the anode separator having fuel gas passage through which a fuel gas flows, on a surface facing the anode catalyst layer,
wherein a specific surface area of the catalyst particles in the anode catalyst layer in a region corresponding to the downstream portion of the oxidant gas passage is set to be smaller than in another region.

6. The fuel cell as defined in claim 1, wherein a diameter of the particles in the cathode catalyst layer facing the downstream portion of the oxidant gas passage is set to be smaller than a diameter of the particles in the cathode catalyst layer facing the upstream portion of the oxidant gas passage.

7. A fuel cell comprising:
a solid polymer electrolyte membrane;
a cathode catalyst layer provided on a side of the solid polymer electrolyte membrane, the cathode catalyst layer comprising catalyst particles each of which comprises a support and a metal catalyst supported on the support;
a cathode separator facing the cathode catalyst layer, the cathode separator having an oxidant gas passage through which an oxidant gas flows, on a surface facing the cathode catalyst layer, and the oxidant gas passage comprising an upstream portion and a downstream portion with respect to a flow of the oxidant gas; and
a current extraction portion electrically connected to the cathode catalyst layer corresponding to the upstream portion,
wherein a specific surface area of the particles in the cathode catalyst layer facing the downstream portion of the oxidant gas passage is set to be smaller than a specific surface area of the particles in the cathode catalyst layer facing the upstream portion of the oxidant gas passage.

8. The fuel cell as defined in claim 7, wherein the fuel cell comprises reaction surfaces, and a reaction surface of the fuel cell corresponding to the downstream portion of the oxidant gas passage has a smaller current density than a reaction surface of the fuel cell corresponding to the upstream portion of the oxidant gas passage.

9. The fuel cell as defined in claim 7, wherein a moisture content of the solid polymer electrolyte membrane is higher in an area corresponding to the downstream portion of the oxidant gas passage than in an area corresponding to the upstream portion of the oxidant gas passage.

10. The fuel cell as defined in claim 7, wherein a humidity of the oxidant gas is higher in a region corresponding to the downstream portion of the oxidant gas passage than in a region corresponding to the upstream portion of the oxidant gas passage.

11. The fuel cell as defined in claim 7, further comprising:
an anode catalyst layer provided on another side of the solid polymer electrolyte membrane, the anode catalyst layer comprising catalyst particles each of which comprises a support and a metal catalyst supported on the support; and
an anode separator facing the anode catalyst layer, the anode separator having fuel gas passage through which a fuel gas flows, on a surface facing the anode catalyst layer,
wherein a specific surface area of the catalyst particles in the anode catalyst layer in a region corresponding to the downstream portion of the oxidant gas passage is set to be smaller than in another region.

12. The fuel cell as defined in claim 7, wherein a diameter of the particles in the cathode catalyst layer facing the downstream portion of the oxidant gas passage is set to be smaller than a diameter of the particles in the cathode catalyst layer facing the upstream portion of the oxidant gas passage.
